(19) United States
(12) Patent Application Publication
(10) Pub. No.: US 2020/0334653 A1
(43) Pub. Date: Oct. 22, 2020

(54) System and Method for a Zero Confirmation Directed Acyclic Graph

(71) Applicant: Jag Sidhu, Surrey (CA)

(72) Inventor: Jag Sidhu, Surrey (CA)

(73) Assignee: Blockchain Foundry Inc., Toronto (CA)

(21) Appl. No.: 16/389,995

(22) Filed: Apr. 21, 2019

(51) Int. Cl. G06Q 20/20; G06Q 20/40; G06Q 40/02; G06Q 20/38; G06Q 30/04; G06Q 20/36; G06F 16/23; G06F 16/27; G06F 16/901

(52) U.S. Cl. CPC G06Q 20/204; G06Q 20/209; G06Q 20/4037; G06Q 40/02; G06Q 20/202; G06Q 2220/00; G06Q 30/04; G06Q 20/3678; G06F 16/2379; G06F 16/27; G06F 16/9024; G06Q 20/3825

(57) ABSTRACT

This invention relates to distributed ledger system implemented as a cryptocurrency or platform for digital commerce. More specifically, this invention relates a system and method for increased transaction and settlement speed using a zero confirmation directed acyclic graph (ZDAG). The invention allows for increased transaction and settlement speed at point of sale for merchants and consumer applications by implementing concurrent processing of transactions with fault tolerance, minimum latency period check, and time based sort of transactions.

### FIELD OF INVENTION

This invention relates to distributed ledger system implemented as a cryptocurrency or platform for digital commerce. More specifically, this invention relates a system and method for increased transaction and settlement speed using a zero confirmation directed acyclic graph (ZDAG). The invention allows for increased transaction and settlement speed at point of sale for merchants and consumer applications.

### BACKGROUND OF INVENTION

In recent years cryptocurrencies and blockchain technologies have reached record highs in valuation and recognition. This technology has captivated public interest with the promise of a new way of doing business and decreased reliance on central authorities via decentralization, immutability, transparency, and security. Bitcoin and Ethereum are the two most popular of the cryptocurrencies. However, adoption is slow and there are not significant numbers of transactions occurring on these platforms (when compared to traditional point of sale or credit card processing systems). Indeed, much of the activity on these platforms has been limited to price speculation and a few proof of concept projects. One limiting factor is the speed and cost of transactions. Due to the cost and long settlement periods, these platforms are unable to compete with the speed and low cost of existing centralized point of sale systems. In sum, current distributed ledger based systems are unable to scale to meet the demands of point of sale merchant and consumer applications. Accordingly, there exists a need for a transaction processing system and method using distributed ledger technology that can securely and cheaply allow for transaction and settlement speed to compete with centralized systems.

### SUMMARY OF INVENTION

The system and method of the present invention utilizes a zero confirmation directed acyclic graph (ZDAG). The ZDAG system allows for scalable transaction and near instant settlement speeds. In essence, ZDAG is a directed acyclic graph (DAG) that validating nodes construct to verify the sequential ordering of transactions that miners have written into blocks. ZDAGs are used by validating nodes across the network to ensure that there is absolute consensus on the ordering of transactions. ZDAGs are topologically sorted by the dependencies of each verified transaction; in effect, creating deterministic graphs. These graphs allow the system of safely and securely record transactions without the need for a central authority.

Furthermore, the real-time topological ordering of transactions as they are received is enough to ensure that the miner can replay the order in a deterministic way such that users can expect the replay of events in a block to match that of the events that happened in real-time, this is made possible through the probability of the mesh network propagating the transactions in real-time to the rest of the network including miners within a predetermined amount of time (we set 10 seconds as the predetermined barometer of how long it would take worst case for the network to see every message and particularly offending messages such as double-spend attempts; however, as hardware becomes more powerful and network speeds increase, this time may be decreased).

### ZDAG Settlement

ZDAG implements a zero-confirmation pseudo settlement policy that allows near instantaneous settlement. Unlike existing systems such as Bitcoin, ZDAG does not require validating nodes to confirm a transaction before broadcasting that transaction to the receiver via the network. Instead, transactions are broadcasted by nodes across the network without having to confirm the transaction.

### ZDAG Ordered Transactions

Additionally, the network anticipates what transactions will be in the next block and how they will be ordered with confidence. During the creation of a block, the miner constructs an ordered list of transactions out of its memory pool which is sorted by time. Traditionally, miners select the transactions with the highest fees. However, in this system, miners must order the transactions based on the time of occurrence. The time based sort adds a negligible processing step that is done automatically upon creation of a block. Requiring transactions to be ordered by time allows the network to recreate all transactions in an ordered and predictable way; thus, allowing the network to near instantly settle transactions after a few checks are performed. Successful miners write these lists into new blocks, which then go on to be either accepted or rejected by validating nodes across the network.

Concurrent Processing with Fault Tolerance

The validating nodes use the transaction lists contained within the blocks to create ZDAGs, which they can cross-check to determine whether the network is in a deterministic state. If the network is in a deterministic state, meaning that verifying nodes and miners have conflicting results, then the conflicting transactions will be rejected, and the block will also be rejected. The senders of such conflicting transactions may also be flagged so recipients can easily check if they are accepting money from a sender that is potentially malicious.

Normally the network functions in concurrent processing mode and instantly broadcast transactions as they are received and then concurrently check them. However, as soon as a node identifies a bad transaction, it broadcasts this to the entire network and the network is switched to a deterministic state/mode for a predetermined amount of time. In the deterministic state, the network is in single threaded mode wherein instead of automatically broadcasting transactions before checking them, the node and network must check each transaction before sending it to the next node. The network remains in single threaded mode for a predetermined amount of time and if there are no errors discovered during that time, the network reverts back to normal or concurrent processing mode.

### Minimum Latency

To prevent double spending, the system and method implements a minimum latency for zero confirmation transactions in an interactive point of sale application. At the beginning of each transaction, a non-enforced minimum delay is applied to subsequent transfers made by the same asset holder. If a user sends two transactions within the minimum delay period of each other, then enough nodes across the network would be able to determine which transfer is the original. However, if a user sends two transactions without the minimum delay applied between them, then receiving nodes on the network will reject the transactions because they do not adhere to the minimum delay protocol and a conflict state is set and the conflict will be relayed across the network as discussed above. In sum, the network does not allow for multiple transactions to be sent right after each other, without a minimum delay period between them.

However, in some embodiments, transactions that are sent without honoring the minimum delay period can still be accepted if they pass additional checks. For instance, if the sender has more than sufficient funds in the account to honor both transactions, then the system would be able to maintain its speed and low cost while maintaining security and transaction confidence. In these embodiments, the system need not reject the transaction, but merely flag them for additional checks such as sender balance check. When a potential double spend is detected, the system merely flags the transaction and broadcasts to the network. Ultimately, the receiver can run additional sender balance check and determine whether to accept the flagged transaction.

Any discrepancies between the real-time state and proof of work block will be resolved upon the confirmation of a block, as proof of work always rolls back to the previous state and replays the correct order of events as seen by the miner. By using the probabilistic approach, ZDAG transactions are able to be settled in real-time with confidence and negligible risk of double-spending over the minimum latency time. The memory pool validation and network relay of transaction messages is highly optimized through parallel execution and will allow for a probabilistic scenario whereby the chance of the miner not seeing transactions in the same order as the majority of the network after the minimum latency period is negligible.

### Incentivized High Throughput Relay

The system and method also implements a bonded validator system in which each validating node must bond a certain number of cryptocurrency or virtual asset. This incentivizes nodes to be master nodes and allows a mesh network to be created, maintained, and propagated. Nodes are incentivized to bond because they will receive a guaranteed return set by the system. By having more validating nodes, the system creates redundancy and allows transactions to propagate faster with increased transactional confidence.

### BRIEF DESCRIPTION OF DRAWINGS

Preferred embodiments of the present invention are described with reference to the following drawings, wherein:

FIG. 1 depicts the system sending a transaction through a blockchain network in accordance with an embodiment of the present invention.

FIG. 2 is a flow chart depicting how a receiver node processes a transaction in accordance with an embodiment of the present invention.

FIG. 3 is a flow chart depicting how nodes relay and perform parallel signature verification in both single threaded mode and normal or concurrent processing mode.

FIG. 4 is a flow chart depicting how miners process transactions by creating ZDAGs and forming blocks for confirmation by validating nodes in accordance with an embodiment of the present invention.

FIG. 5 is a flow chart depicting how validating nodes confirm a block received from a miner and update the balances on the network in accordance with an embodiment of the present invention.

FIG. 6 is a flow chart depicting the system implemented as part of a point of sale terminal at a merchant location.

### DETAILED DESCRIPTION

Described herein is a system and method for increased transaction and settlement speed using a zero confirmation directed acyclic graph (ZDAG). The invention allows for increased transaction and settlement at point of sale for merchants and consumer applications.

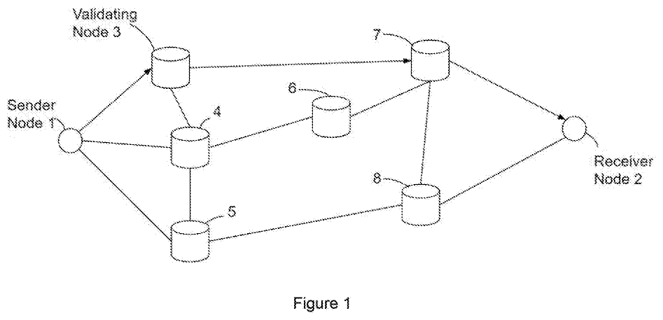

FIG. 1 is a diagram that depicts the system in accordance with an embodiment of the present system. The system is comprised of a plurality of nodes and validating nodes. Users typically interact with the system via a node. For the purposes of this discussion, a user, sender, receiver, or node will be understood to be either a person or person interacting with a computer, mobile phone, server, pos terminal, or similar electronic device capable of accessing the internet. In an exemplary embodiment, a sender initiates a transaction via a node 1 which is intended to be received at a receiving node 2. While the embodiment in FIG. 1 only shows sender and receivers as simple nodes, sender and receiver can also be validating nodes 3-8. The sender node 1 initiates a transaction and broadcasts it to the network via a series of validating nodes 3-8. In the example of FIG. 1, the transaction is broadcasted to validating nodes 3 and 7 before it is received at receiving node 2.

Below is a detailed outline for a ZDAG transfer and settlement:

Outline for a ZDAG transfer and settlement: (algorithm 1 and 2)
1. Sender node 1 begins process by broadcasting that it has sent some amount of cryptocurrency or asset token to another address;
2. Validating nodes 3 and 7 relay transaction before verification;
3. Transaction is ultimately relayed to receiver address at the receiving node 2;
4. Balance may be immediately realized in receiver wallet upon reception of transaction;
5. Receiver node 2 then checks whether the transaction honors the minimum latency period (in one embodiment, the latency period is 10 seconds; however, as hardware becomes more advanced, latency can be reduced.);
   a. If receiver node 2 determines that the sender is not following the minimum latency period, the receiver node 2 may decide not to honor at the point of sale and either wait or reject the transaction;
   b. If receiver node 2 determines the sender is following the minimum latency period, then the receiver node 2 may automatically reflect the transaction;
6. Receiver node 2 also checks for balance overflows and rejects if balances are subject to overflow (they go less than zero if the transaction were to be accepted). Thus miners are forced to include only chains of transactions that are valid.
   a. If the balance overflow check is failed, the transaction is rejected, flagged, and broadcasted to the network;
   b. If the balance overflow check is passed, even if the minimum latency period is failed, the receiver node 2 may choose to accept the transaction because the sender has enough balance to honor both transactions.

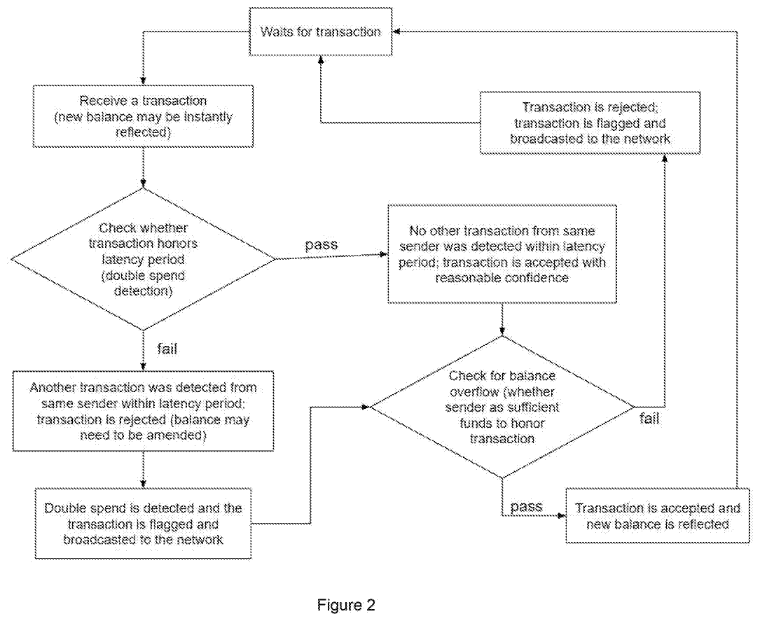

FIG. 2 is a flow chart of how a receiver node processes a transaction in accordance with an embodiment of the present invention. In some embodiments, and as discussed above, instead of simply rejecting a transaction that fails the latency period check, the receiver node can simply flag the transaction, and performs an additional check of the sender's balance from the previous block to determine whether the sender has sufficient funds to satisfy all outstanding transactions. If so, the receiver node may accept the flagged transaction.

When a valid transfer is made, the miners that receive the broadcasted transaction include it in their queue of unconfirmed transactions to be mined into a block. The transactions in this list are ordered by time before being added to a block so that validating nodes across the network can create ZDAGs to ensure that the newest transactions lead the graph.

In some embodiments, the validating nodes do not need to construct ZDAGs to determine the validity of a properly constructed block, the block is checked for strict balances (no overflows allowed) and is ensured to validate properly on acceptance instead. This greatly reduces complexity of work needed on validating nodes and allows for higher throughput overall in the system from not having to do these computationally expensive checks.

Although the receiver of a transaction is able to realize their funds immediately upon receiving notice of the transaction, the transaction is not truly completed until a block has been mined; prior to the mining of a block, the transaction is simply settled with confidence that it will persist. Once a block a block has been mined, the transaction is confirmed, and the funds are finalized with confidence of proof of work.

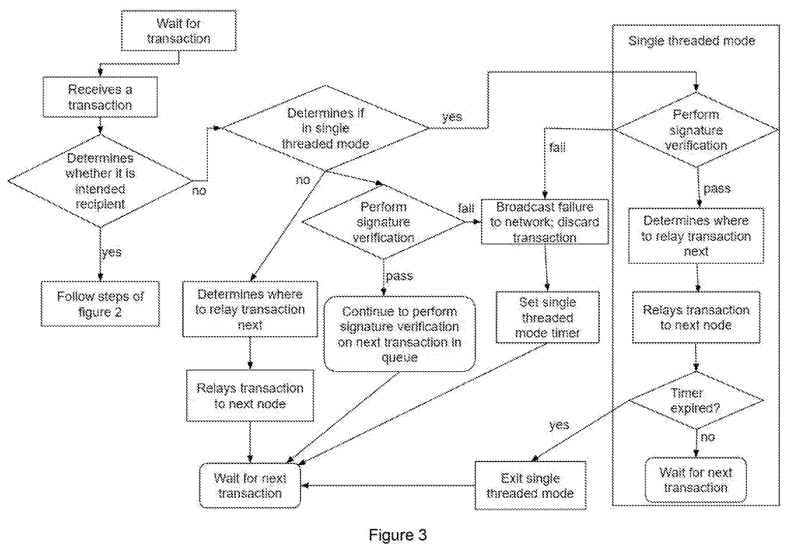

FIG. 3 is a flow chart depicting multithreading and parallel signature verification in accordance with an embodiment of the present invention. Essentially, the system and method functions in two modes. In a normal mode, the system functions with parallel signature verification and automatically relays transactions after determining that the transaction is intended for a different node. At the same time or sometime after the node relays the transaction, the node performs signature verification by comparing the public and private keys. This allows transactions to be broadcasted across the network much faster than existing systems.

However, if at any time a node determines that a signature verification is failed, the node sets a timer, single threaded mode timer, and switches to single threaded mode and broadcasts the failure to the network. In this mode, the system and network is said to be in a deterministic state which means that the node (and network) will no longer perform parallel signature verification. Instead every node must verify signature before relaying any transaction. The node and network remains in a deterministic state until the expiration of the single threaded mode timer. In one embodiment of the present invention, the single threaded timer is set for 60 seconds. If at any given time another signature verification is failed, the timer is reset. Thus, the system can only revert back to normal mode with parallel signature verification if there are no failed signature verifications for at least 60 seconds (in this instant example). However, it should be understood that different times can be set based on the need and preference of the system creators. Single threaded mode prevents DDOS attacks.

In some embodiments, the system is capable of performing multi signature verification. In these embodiments, signatures do not change hash value.

The outline below summarizes the steps required for mining a block in accordance with an embodiment of the present invention: Mining step (algorithm 3)
1. Order their queue of unconfirmed transactions by time and include these into a new block which they compete to mine onto the network.
2. Once a miner succeeds in creating a block, they broadcast it to the network.
3. Network's validating nodes use the newly created block's properties to create ZDAGs, which will be used to determine the validity of the transactions it contains.
4. Once the validating nodes are able to confirm the validity of transactions and ultimately the block, the block is accepted and the miner is rewarded.

In some embodiments the validating nodes do not need to create ZDAGs because the miners have already ordered the transactions by time, so the validating nodes need only double check their work.

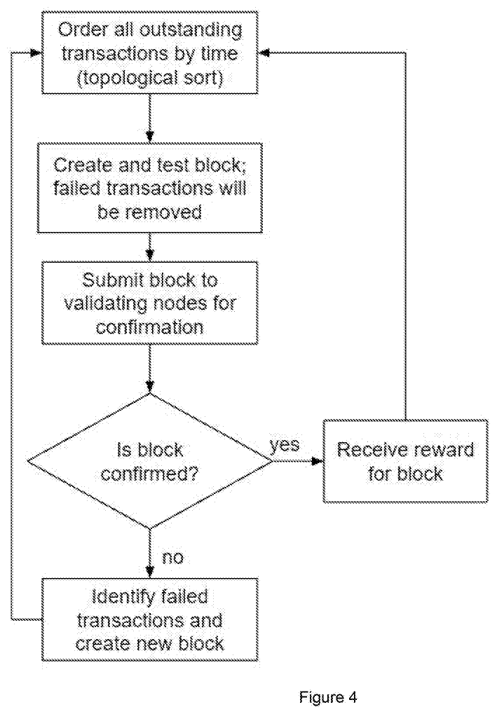

FIG. 4 is a flow chart depicting the logic for a miner to mine a block in accordance with an embodiment of the present invention. In this embodiment, the miners must order the transactions based on time, in essence creating a ZDAG which can more easily be confirmed since the transactions can be played back by order of occurrence and confirmed.

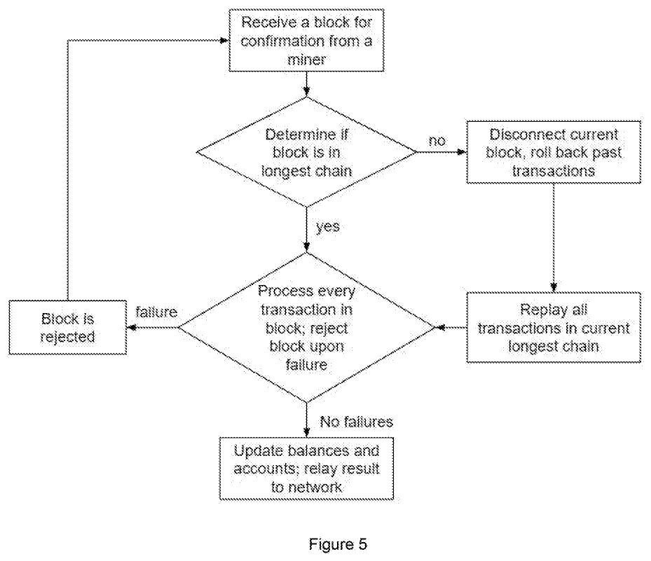

FIG. 5 is a flow chart depicting the logic for a validating node to confirm a block received from a miner. It is important to note that while transactions may be realized at receiver nodes and new balances updated, the transaction is not settled until it is mined and confirmed by a validating node. However, given the numerous checks and balances that exist in the system, as discussed above, the transactions can be settled and reflected with a high certainty that they will persist and be validated.

The system is preferably implemented as a mesh network in which many of the nodes are validating nodes. Validating nodes must have sufficient processing power to perform validation checks. To incentivize, build, and maintain a healthy mesh network, the system implements a bonding scheme in which validating nodes must bond a minimum amount of coin or assets and receive a guaranteed return for their bonded assets.

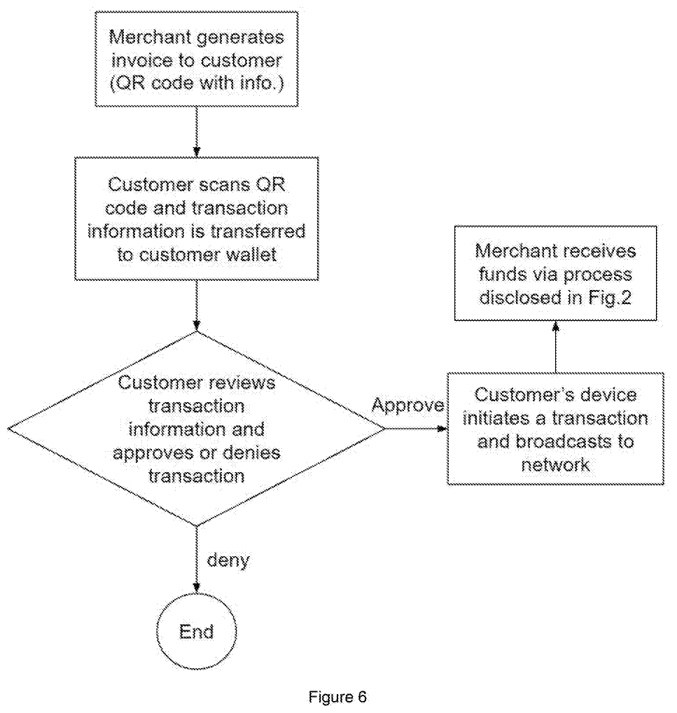

In one embodiment, the system and method are implemented in a POS terminal, mobile phone, mobile computer, or tablet device. Below is an outline of the process depicted in FIG. 6:
1. A customer shopping at a merchant location brings an item or orders a service at the POS terminal. This process can either be done be the customer herself or assisted by a cashier at the merchant location.
2. The item is rung up at the POS terminal.
3. POS terminal generates an invoice to customer and displays a QR code a. QR code includes information on purpose of payment, amount, date and recipient.
4. Customer uses mobile device to scan QR code.
   a. Invoice information is stored on customer wallet.
5. Customer approves or denies transaction.
   a. If customer denies, process ends.
6. If customer approves transaction, Customer's device broadcasts transaction and Merchant device receives transaction as described in FIG. 2 above and the detailed description thereof.

In other embodiments, the POS system is implemented in combination with a stable coin (asset backed by fiat). Accordingly, this system would be implemented as a mobile banking app in which a user can login and access her bank account. However, the use of the system described in the present invention provides benefits over existing merchant processing systems in that it does not have to go through the SWIFT (Society for Worldwide Interbank Financial Telecommunication) System which has higher fees than that of the current invention. In essence, the system of the present invention allows merchants and customers to sideset existing infrastructures with high fees set by banks and larger institutions that are often unclear and arbitrary. On the other hand, the fees in the system of the present invention are based on a readily ascertainable formula of supply and demand.

Below are sample pseudo code in accordance with an embodiment of the present invention:

Algorithm 1: Mempool parallel verification and Z-DAG consensus in real-time
Result: Asset allocation balances will transfer in real-time as soon as the message is received
aross network participants.

| | |
|---|---|
| 1 | Call assetallocationsend RPC; |
| 2 | Sign and send TX to network; |
| 3 | for each transaction received from peer do |

| | |
|---|---|
| 4 | Accept to memory pool; |
| 5 | if now( ) − nLastMultithreadMempoolFailure < 60 seconds then |

| | |
|---|---|
| 6 | set bMultiThreaded = false; |

| | |
|---|---|
| 7 | else |
| 8 | Preliminary input checks same as Bitcoin; |
| 9 | if bMultiThreaded == false then |

| | |
|---|---|
| 10 | for all inputs do |

| | |
|---|---|
| 11 | Do signature verification; |
| 12 | if If signature verification fails then |

| | |
|---|---|
| 13 | return false; |

| | |
|---|---|
| 14 | else |

| | |
|---|---|
| 15 | Add transaction to memory pool; |

| | |
|---|---|
| 16 | Relay transaction to network peers; |

| | |
|---|---|
| 17 | else |

| | |
|---|---|
| 18 | Add transaction to memory pool; |
| 19 | Relay transaction to network peers; |
| 20 | Add transaction to thread pool queue for signature verification; |
| 21 | Thread pool concurrently checks for signature validity; |
| 22 | if signature verification fails then |

| | |
|---|---|
| 23 | set nLastMultithreadMempoolFailure = now( ); |
| 24 | return; |

| | |
|---|---|
| 25 | else |
| 26 | Zero confirmation Syscoin consensus updates; |
| 27 | if update fails then |

| | |
|---|---|
| 28 | set nLastMultithreadMempoolFailure = now( ); |
| 29 | return; |

| | |
|---|---|
| 30 | else |

Algorithm 2: Asset Allocation Sender Status RPC
Result: Check that a transaction received is indeed valid according to Z-DAG interactive
protocol rules

| | |
|---|---|
| 1 | set status = OK; |
| 2 | if sender was found in assetAllocationConflicts (double-spend detection buffer) then |

| | |
|---|---|
| 3 | set status = MAJORCONFLICT; |

| | |
|---|---|
| 4 | else |

| | |
|---|---|
| 5 | Order all in-transit asset allocations from sender in order by ascending time; |
| 6 | set mapBalances[sender] = sender balance from last PoW block (last known good state); |
| 7 | for all in-transit asset allocations do |

| | |
|---|---|
| 8 | set txRef = in-transit asset allocation fetched from mempool; |
| 9 | if txRef is invalid then |

| | |
|---|---|
| 10 | continue; |

| | |
|---|---|
| 11 | else |
| 12 | if time received of 2 adjacent transactions <= minimum latency (10 seconds) then |

| | |
|---|---|
| 13 | set status = MINORCONFLICT; |

| | |
|---|---|
| 14 | else |
| 15 | for all allocations sent in this transaction do |

| | |
|---|---|
| 16 | set senderBalance = senderBalance − sending amount; |
| 17 | set mapBalances[sender] = mapBalances[sender] − |

sending amount;

| | |
|---|---|
| 18 | if senderBalance <= 0 then |

| | |
|---|---|
| 19 | set status = MINORCONFLICT; |

| | |
|---|---|
| 20 | else |

| | |
|---|---|
| 21 | return status; |

Algorithm 3: Block Construction
Result: A Block is constructed out of transactions related to Syscoin and/or Syscoin assets

| | |
|---|---|
| 1 | Craft block from transactions queued in the memory pool, ordered by highest fee first; |
| 2 | Order all in-transit asset allocations from sender in order by ascending time; |
| 3 | Test validity of Syscoin asset transactions in block; |
| 4 | if If block is invalid because transactions cause balance overflows then |

| | |
|---|---|
| 5 | remove invalid transactions from block and call Block Construction again; |

| | |
|---|---|
| 6 | else |
| 7 | Test validity of standard Syscoin block transactions; |
| 8 | Solve block PoW and relay block to the network; |

1. A system for processing transactions using a distributed ledger comprising:
a plurality of computers;
a point of sale terminal for initiating a transaction having programming code stored in memory to:
generate a transaction invoice message;
receive a transaction in response to the transaction invoice message from a sender account;
determine whether the received transaction honors a minimum latency period; and
accept transaction if minimum latency period is honored.

2. The system of claim 1 wherein the transaction invoice message is a QR code with transaction information.

3. The system of claim 1 wherein determining whether the received transaction honors the minimum latency period comprises checking whether there was a double spend within a predetermined amount of time.

4. The system of claim 1 wherein the point of sale terminal further having programming code to flag a transaction and broadcast a double spend notification to at least one of the plurality of computers if the transaction fails to honor the minimum latency period.

5. The system of claim 1 wherein the point of sale terminal further having programming code to perform a balance overflow check on the sender account and if the check is passed, accepting the transaction.

6. The system of claim 2 wherein the point of sale terminal further having programming code to perform a balance overflow check on the customer's account and if the check is passed, accepting the transaction.

7. The system of claim 1 wherein at least one of the plurality of computers having programming code stored in memory to operate as part of a distributed ledger.

8. The system of claim 7 wherein the at least one of the plurality of computers further having programming code stored in memory to:
receive the transaction in response to the transaction in voice message;
determine whether it is in single threaded mode;
If it is not, then forwarding the transaction to the point of sale terminal and concurrently perform signature verification.

9. The system of claim 7 wherein the at least one of the plurality of computers further having programming code stored in memory to:
receive the transaction in response to the transaction in voice message;
determine whether it is in single threaded mode;
If it is not, then forwarding the transaction to the point of sale terminal and thereafter perform signature verification.

10. A method for processing transactions on a blockchain comprising:
generating a transaction invoice message;
receiving a transaction in response to the invoice message;
checking whether the sender has sent another transaction within a minimum latency period;
performing a balance overflow check on the sender's account;
accepting the transaction and reflecting the new balance before the next block is mined.

11. The method of claim 10 further comprising:
receiving a second transaction;
determining whether the transaction is intended for another recipient;
if the transaction is intended for another recipient, broadcasting the transaction to another node or the intended recipient; and
concurrently or after broadcasting the transaction, performing signature verification on the second transaction.

12. The method of claim 11 further comprising:
if the signature verification on the second transaction fails, broadcasting the failure to the blockchain; and
switching to single threaded mode and initiating a single threaded mode timer.

13. The method of claim 12 wherein in single threaded mode, signature verification must be performed before any transaction can be broadcasted.

14. A method for processing transactions on a blockchain comprising:
receiving a transaction;
determining whether the transaction is intended for a different recipient;
if the transaction is intended for a different recipient, determining whether the network is in single threaded mode;
if the network is not in single threaded mode, broadcasting the transaction to the intended recipient; and
concurrently or after broadcasting the transaction, performing signature verification on the transaction.

15. The method of claim 14 wherein the determining whether the network is in single threaded mode further comprising checking whether a single threaded mode timer has expired;
if the single threaded mode timer has not expired; performing signature verification on the transaction before broadcasting it to the intended recipient.

16. The method of claim 14 further comprising;
If signature verification fails, initiating a single threaded mode timer and broadcasting the failure to the blockchain network.

17. The method of claim 16 further comprising:
performing signature verification on all subsequent transactions until the single threaded mode timer has expired;
if there is another failed signature verification, restarting the single threaded mode timer.

18. The method of claim 14 further comprising:
if the transaction is not intended for another recipient, checking whether the sender has sent another transaction within a minimum latency period;
If the minimum latency period check is passed, accepting the transaction and reflecting a new balance.

19. The method of claim 18 further comprising:
if the minimum latency period check is failed (meaning the sender has sent a second transaction within the minimum latency period), performing a balance overflow check for the received transaction and the second transaction;
If the balance overflow check on both transactions is passed, accepting the transactions and reflecting a new balance for both transactions.

20. The method of claim 18 further comprising:
if the minimum latency period check is failed (meaning the sender has sent a second transaction within the minimum latency period), flagging the transaction, broadcasting an attempted double spend to the network, and rejecting the transaction.
